(19) United States
(12) Patent Application Publication
(10) Pub. No.: US 2007/0115256 A1
(43) Pub. Date: May 24, 2007

(54) Apparatus, medium, and method processing multimedia comments for moving images

(75) Inventors: Hye-jeong Lee, Seoul (KR); Ji-hye Chung, Seoul (KR); Kee-eung Kim, Seoul (KR); Yeun-bae Kim, Seongnam-si (KR); Min-kyu Park, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/584,494

(22) Filed: Oct. 23, 2006

(30) Foreign Application Priority Data
Nov. 18, 2005 (KR) 10-2005-0110935

(51) Int. Cl. G09G 5/00

(52) U.S. Cl. 345/156

(57) ABSTRACT

An apparatus, medium, and method for processing a multimedia comment for a moving image, where a user can input a comment of various multimedia types while viewing a moving image, and view the moving image along with the input comment. The apparatus for processing multimedia comments for a moving image may include a user input unit allowing a user to input a multimedia type comment for a predetermined moving image, a comment storage unit storing the input comment, and a control unit modifying the stored comment in accordance with characteristics of the moving image when the moving image is played, and outputting the modified comment.

### CROSS-REFERENCE TO RELATED APPLICATIONS

This application is based on and claims priority from Korean Patent Application No. 10-2005-0110935, filed on Nov. 18, 2005, the disclosure of which is incorporated herein in its entirety by reference.

### BACKGROUND OF THE INVENTION

1. Field of the Invention

An embodiment of the present invention relates to an apparatus, medium, and method for processing a multimedia comment for a moving image and, more particularly, to an apparatus, medium, and method for processing a multimedia comment for a moving image, whereby a user can input a comment of diverse multimedia types while viewing a moving image, and can view the moving image along with the input comment.

2. Description of the Related Art

Generally, comments are used with an image or a moving image to improve information communication and facilitate management of information in conjunction with the image or moving image. For example, in the case of an image, a user may input a comment for the entire image or just a predetermined portion. In the case of a moving image, the user may input a comment to a portion provided for such a comment after viewing the moving image.

Furthermore, text type comments are frequently used, with the user selecting an image or moving image for comment and may input a predetermined text type comment to a given comment portion. At this time, since the user cannot input the comment while viewing the moving image, the user inputs the comment after completion of the moving image playback. Accordingly, the user can record a comment for a corresponding scene in a separate recording medium and the extent of that comment depends on available storage capacity.

Furthermore, the conventional types of comments input by a user are mainly limited to texts or images are insufficient and do not permit the user to express sufficient sensitiveness through comments for the image or the moving image.

Accordingly, the inventors have found it desirable to provide a method of allowing users to interactively input a comment for a predetermined scene while viewing a moving image and permit the moving image to be output along with the input comment when the moving image is reproduced. Further, in addition to text type comments or the image type comments, the inventors have found desirable to provide a method for input of a comment of various types to sufficiently express the user's sensitiveness.

In a conventional system, Japanese Patent Unexamined Publication No. 2005-026384 discusses the providing of comment information, wherein comment information is displayed at the center of an image for input of comment information, with the display frame being enlarged, reduced, and moved to designate comment information in a desired portion. Here, further discussed is providing comment information of an image file or an audio file to a designated portion when the image is taken. However, this conventional system relates to providing of previously designated comment information to an image taken by a digital camera, and, thus, fails to solve the aforementioned conventional drawbacks or even suggest a desired detailed method for input of comments of various multimedia types to a predetermined scene of a moving image or even outputting such a moving image along with the input comment.

Thus, there is a need for at least a desired detailed method for input of comments of various multimedia types to a predetermined scene of at least a moving image and a method for outputting such a moving image along with the input comment.

### SUMMARY OF THE INVENTION

Accordingly, an embodiment of the present invention has been designed to solve the above-mentioned conventional problems, with an aspect of embodiments of the present invention being to provide an apparatus, medium, and method for processing multimedia comment for a moving image, where a user can input comments of various multimedia types while viewing at least a moving image or select a corresponding comment among previously designated comments, and further to view the moving image along with such comments.

Another aspect of an embodiment of the present invention is to provide an apparatus, medium, and method for processing a multimedia comment for a moving image, where a user can input a desired comment, and use a user's viewing environment as such a comment.

Additional aspects and/or advantages of the invention will be set forth in part in the description which follows and, in part, will be apparent from the description, or may be learned by practice of the invention.

To achieve the above and/or other aspects and advantages, embodiments of the present invention include an apparatus for processing multimedia comments for moving images, including a user input unit for a user to input a multimedia type comment for a particular moving image, and a control unit to selectively modify the comment in accordance with characteristics of the moving image when the moving image is reproduced.

The multimedia type comment may be of at least one type of a text, image, icon, moving image, voice, and sound type.

Further, the input comment may be stored together with synchronization information for a corresponding scene of the moving image.

The control unit may modify a multimedia type of the comment in accordance with characteristics of the moving image, which may include a theme of the moving image, a keyword, a color distribution, and a position of an object within the moving image.

In addition, the control unit may selectively output a select comment selected from a plurality of user input comments for a predetermined scene of the moving image in accordance with characteristics of the select comment.

The apparatus may further include a designated comment storage to store previously designated user input comments in accordance with characteristics of the moving image, and a viewing environment storage to store at least one viewing environment of the user in accordance with a user's indication for input of a comment when the moving image is reproduced.

Here, the user may select at least one of the previously designated user input comments corresponding to the played moving image through the user input unit.

The control unit may further modify the selected at least one of the previously designated user input comments in accordance with characteristics of the moving image when the moving image is reproduced.

In addition, control unit may modify the selected at least one of the previously designated user input comments in accordance with characteristics of the selected at least one of the previously designated user comments when the moving image is reproduced.

The viewing environment storage may store at least one of a surrounding environment of the user and a viewing appearance of the user when the user views the reproduction of the moving image. Here, the at least one viewing environment may be of at least one type of an image, moving image, voice, and sound type.

The viewing environment storage may further store the at least one viewing environment at a predetermined time period or stores the at least one viewing environment according to a predetermined event being generated in the at least one viewing environment.

The control unit may modify the stored at least one viewing environment in accordance with characteristics of the moving image when the moving image is reproduced. Similarly, the control unit may modify the stored at least one viewing environment in accordance with characteristics of the at least one viewing environment when the moving image is reproduced.

In addition, the control unit may further control a reproduction of the selectively modified comment together with the moving image.

To achieve the above and/or other aspects and advantages, embodiments of the present invention include a method of processing multimedia comments for moving images, including inputting a multimedia type comment by a user for a particular moving image, and selectively modifying the comment in accordance with characteristics of the moving image when the moving image is reproduced.

The multimedia type comment may be of at least one type of a text, image, icon, moving image, voice, and sound type.

The method may further include storing the comment together with synchronization information for a corresponding scene of the moving image corresponding to the comment.

The method may still further include outputting the comment through a selective modifying of a multimedia type of the comment in accordance with characteristics of the moving image, which include at least one of a theme of the moving image, a keyword, a color distribution, and a position of an object within the moving image.

Further, the inputting of the multimedia type comment may further include selecting at least one of a plurality of previously designated user input comments for a predetermined scene of the moving image in accordance with characteristics of the selected comment.

The method may still further include storing previously designated user input comments in accordance with characteristics of the moving image, and storing at least one viewing environment of the user in accordance with a user's indication for input of a comment when the moving image is reproduced.

Here, the inputting of the multimedia type comment may further include selecting at least one of the previously designated user input comments corresponding to the reproduced moving image.

The method may further include outputting the selected at least one of the previously designated user input comments through modifying of the selected at least one of the previously designated user input comments in accordance with characteristics of the moving image when the moving image is reproduced.

Similarly, the method may include outputting the selected at least one of the previously designated user input comments through modifying the selected at least one of the previously designated user input comments in accordance with characteristics of the selected at least one of the previously designated user input comments when the moving image is reproduced.

The method may further include viewing the at least one viewing environment through storing at least one of a surrounding environment of the user and a viewing appearance of the user when the user views the reproduction of the moving image.

In addition, the at least one viewing environment may be of at least one type of an image, moving image, voice, and sound type.

The storing of the at least one viewing environment may further include storing the at least one viewing environment at a predetermined time period or storing the at least one viewing environment if a predetermined event is generated in the at least one viewing environment.

The method may include outputting the comment through modifying the stored at least one viewing environment in accordance with characteristics of the moving image when the moving image is reproduced.

Similarly, the method may include outputting the comment through modifying the stored at least one viewing environment in accordance with characteristics of the at least one viewing environment when the moving image is reproduced.

The method may still further include reproducing the selectively modified comment together with the moving image.

To achieve the above and/or other aspects and advantages, embodiments of the present invention include at least one medium including computer readable code to control at least one processing element to implement embodiments of the present invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates an apparatus for processing multimedia comments for moving images, according to an embodiment of the present invention;

FIG. 2 illustrates another apparatus for processing multimedia comments for moving images, according to an embodiment of the present invention;

FIG. 3 illustrates a method of processing multimedia comments for moving images, according to the an embodiment of the present invention;

FIG. 4 illustrates an overlap scene between a position of an object and a position of a comment within a moving image, according to an embodiment of the present invention;

FIG. 5 illustrates a scene where a position of a comment, such as that of FIG. 4, may be modified;

FIG. 6 illustrates a comment selected among comments existing in a predetermined scene of a moving image, according to an embodiment of the present invention;

FIG. 7 illustrates a list of all comments existing in a predetermined scene of a moving image, according to an embodiment of the present invention;

FIG. 8 illustrates another method of processing multimedia comments for moving images, according to an embodiment of the present invention;

FIG. 9 illustrates a list of previously designated comments, according to an embodiment of the present invention; and

FIG. 10 illustrates another method of processing multimedia comments for a moving image, according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

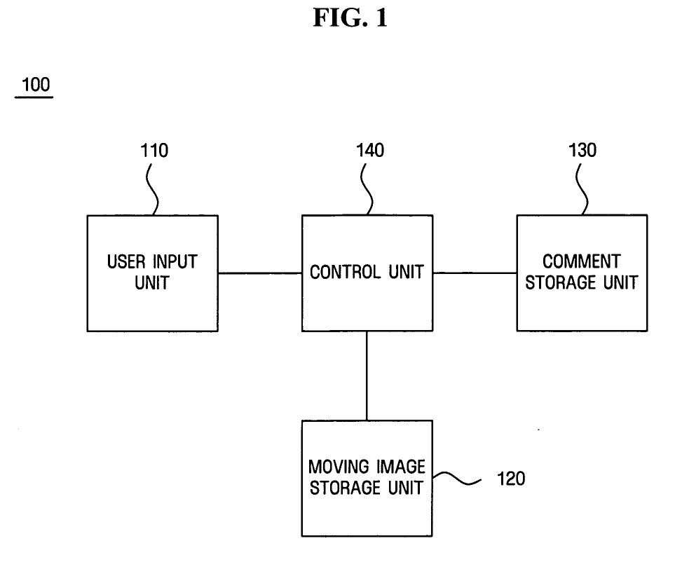

FIG. 1 illustrates an apparatus for processing multimedia comments for moving images, according to an embodiment of the present invention.

As shown in FIG. 1, the apparatus 100 for processing a multimedia comment for a moving image may include a user input unit 110, a moving image storage unit 120, a comment storage unit 130, and a control unit 140, for example.

The user input unit 110 may be any input device that allows a user to input a predetermined multimedia type comment while viewing a moving image, e.g., when the control unit 140 reproduces the moving image stored in the moving image storage unit 120, for example. In one embodiment, although any of a keyboard, mouse, mike, camera and/or camcorder may be used as input devices, embodiments of the present invention are not limited thereto. For example, users may input comments of various multimedia types such as text, icon, image, moving image, voice, and sound through such input devices while viewing the moving image, e.g., as reproduced by the control unit 140.

The moving image storage unit 120 may store multimedia data desired by the user. Here, though the moving image has been illustrated as being stored in the moving image storage unit 120, multimedia data of various types may be stored in the moving image storage unit 120, and alternative storage devices may equally be available.

Similarly, the comment storage unit 130 may store multimedia type comments input by a user, e.g., through the user input unit 110. Comments stored in the comment storage unit 130 may be synchronization information of the moving image in addition to the multimedia type comments input through the user input unit 110, for example. Such synchronization information may include comments input by a user while views a moving image and information of a scene corresponding to the input comment. In one embodiment, a multimedia type comment and synchronization information may be stored together in the comment storage unit 130, though embodiments of the present invention are not limited thereto.

The control unit 140 may further output a moving image, e.g., a moving image stored in the moving image storage unit 120, along with corresponding multimedia type comments, e.g., stored in the comment storage unit 130.

For example, among methods of outputting a moving image together with a corresponding multimedia type comment, an overwriting of the multimedia type comment onto/into the moving image may be performed. However, when a multimedia type comment is overwritten onto/into the moving image, reproduction speeds may become reduced. Accordingly, double buffering or overlay may be used when the moving image is reproduced. Here, when double buffering, in addition to a video memory corresponding to a predetermined scene of the moving image, a separate buffer may be used, and a next scene may have already been previously stored in this buffer so that the scene in the buffer is exchanged with that in the video memory. The mentioned overlay technique is the implementing of a transparent sheet on a moving image screen, with a next scene being displayed in this overlay area.

As described above, the control unit 140 may overwrite the multimedia type comment input by the user onto/into the moving image in accordance with each type of comment. For example, for various multimedia type comments, the control unit 140 may output a text like a caption through a predetermined font, icon, and image, such as with a sticker attached to the current scene, and similarly with the moving image using a sticker attached to the current scene or in the form of a picture in picture (PIP), for example. Here, the control unit 140 may, for example, output voice and sound by lowering the volume of background music of a current moving image.

Furthermore, the control unit 140 may output another type of comment corresponding to each of the various multimedia types. For example, if the user has input a text type comment, the control unit 140 may output an icon type comment corresponding to the input text type comment.

In addition, the control unit 140 may output the various multimedia type comments by converting their types in accordance with characteristics of the moving image being played. Specifically, in one embodiment, the control unit 140 may convert the multimedia type comments in accordance with a theme of the moving image, keyword, color distribution, and a position of an object within the moving image.

For example, if the user inputs a text type comment “Happy” and the theme of the moving image is “Trip”, the control unit 140 may add a mountain-like image to the input text type comment. If the theme of the moving image is “Wedding”, the control unit 140 may add a flower-like image to the input text type comment. Similarly, if the color distribution of the moving image is white and a color of the text type comment is white, the control unit 140 may convert the color of the text type comment into black. Moreover, if the output position of the text type comment overlaps the position of an object within the moving image, the control unit 140 may convert the position of the text type comment to prevent the object within the moving image from being covered with the text type comment.

On the other hand, if plural comments are input to a predetermined scene of a moving image, the control unit 140 may generate a list of the input comments. At this time, the control unit 140 could output only a comment selected from the list of the comments. For example, if too many comments for the predetermined scene have been input, the control unit 140 may output only the latest comment that was input for the predetermined scene. Further, in the case of comments being accumulated, alternate selection techniques may be used, such as basing the selection on a degree of popularity, with the control unit 140 outputting only a single comment according to popularity weights of the accumulated results. As another example, the most common comment entry may be selected.

In more detail, in one embodiment, the moving image to which the comment has been input may commonly be used among multiple users within network, for example. Accordingly, if one user inputs a comment to a scene of a moving image, another user who commonly uses the corresponding moving image may also input a comment to the scene. In this way, if a comment for a predetermined scene is input to a predetermined moving image through many users, the number of comments input to the corresponding scene increases and the corresponding scene may become covered due to a sheer number of the comments.

To prevent such an occurrence, the control unit may output only the latest comment. In addition, if the user desires to view all the comments input to the corresponding scene, the control unit may permit the output of a list of the input comments to allow the user to identify all the comments, for example. Similar to above, alternate selection techniques may equally be available.

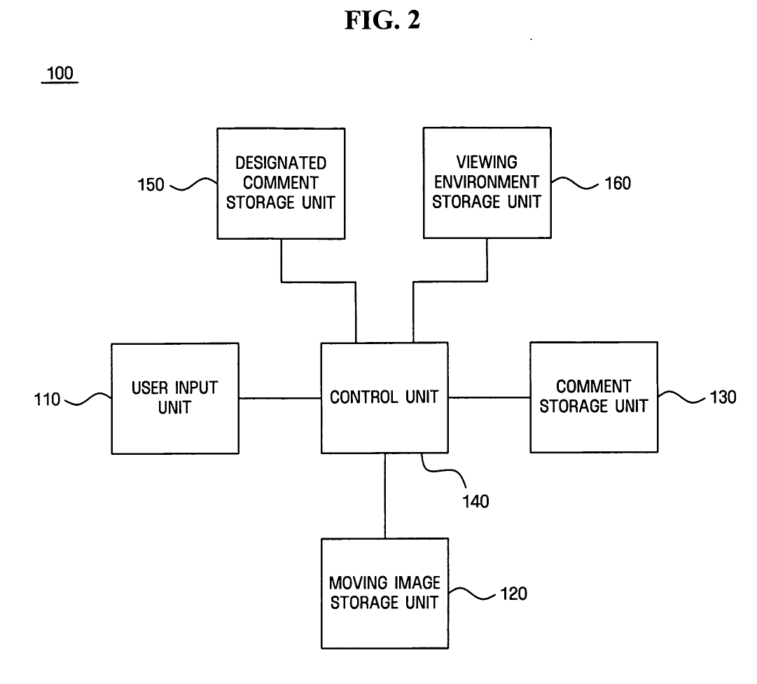

FIG. 2 illustrates an apparatus for processing multimedia comments for moving images, according to another embodiment of the present invention.

As shown in FIG. 2, the apparatus 100 for processing multimedia comments for moving images may, in addition to the aforementioned units, include a designated comment storage unit 150 storing previously designated comments in accordance with a predetermined moving image and a viewing environment storage unit 160 storing a viewing environment of the user, for example.

The designated comment storage unit 150 may store previously designated various multimedia type comments in accordance with a theme of the moving image and a keyword, for example. Here, in one embodiment, the user may select a desired comment among various multimedia type comments stored in the designated comment storage unit 150 and input the selected comment to the user input unit 110. At this time, a comment listing for the previously designated multimedia type comments may be generated/stored, and the user can select a desired comment among the comment listing, e.g., stored in the designated comment storage unit 150. In addition, the designated comment storage unit 150 may store previously designated various multimedia comments and index information of corresponding multimedia comments. In one embodiment, although previously designated various multimedia comments and index information of corresponding multimedia comments may be stored together in the designated comment storage unit 150, they may equally be stored in separate storage units. For example, the previously designated various multimedia comments could be stored in the comment storage unit 130 while the index information of the corresponding multimedia comment could be stored in the designated comment storage unit 150.

At this time, the comment selected by the user may be stored in the comment storage unit 130, e.g., through the user input unit 110, in the same manner as the comment directly input by the user. Accordingly, the control unit 140 may determine the multimedia type comment selected by the user through the index information when outputting the previously designated multimedia type comments to play the moving image.

In addition, the viewing environment storage unit 160 may store the viewing environment when the user views a predetermined moving image. In one embodiment, the viewing environment may be a surrounding environment of the user and a viewing appearance of the user. The viewing environment may further be of image, moving image, voice, and sound.

Furthermore, the viewing environment storage unit 160, for example, may store the viewing environment at a predetermined time period, and store the viewing environment if a predetermined event, such as voice level of a predetermined size or greater, is sensed or if a predetermined motion is sensed from the user. At this time, the viewing environment storage unit 160 may store the viewing environment and synchronization information between the viewing environment and the moving image. Accordingly, the control unit 140 may output the viewing environment along with the moving image in the same manner as the aforementioned various multimedia comments.

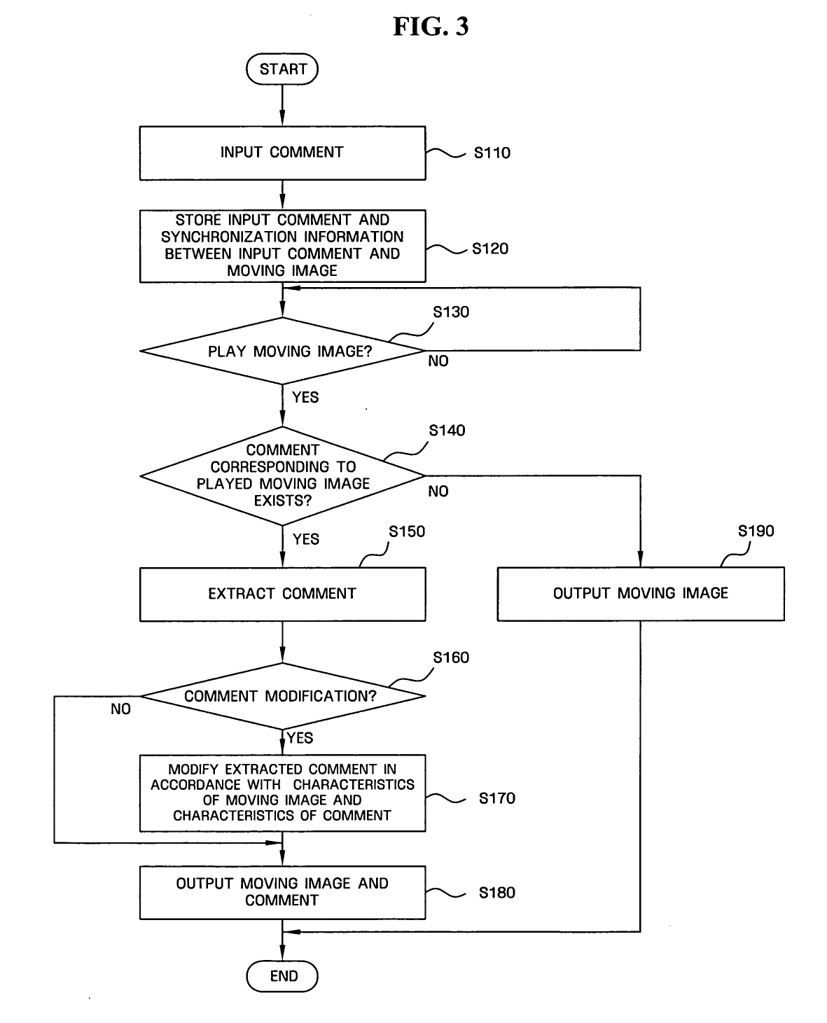

FIG. 3 illustrates a method of processing multimedia comments for moving images, according to an embodiment of the present invention. Referring to FIG. 3, the user may input a comment while viewing a moving image, e.g., stored in the moving image storage unit 120, which may be a moving image to which comments have not already been input.

As shown in FIG. 3, the user may input the whole moving image or the multimedia type comment for the predetermined scene when the moving image is reproduced, in operation S110. At this time, the user can input comments of various multimedia types through the aforementioned various input devices, for example.

The input comment may then be stored, e.g., in the comment storage unit 130, along with synchronization information with a corresponding moving image, in operation S120.

The control unit 140 may further determine whether corresponding comments are stored, e.g., in the comment storage unit 130, in operation S140, when the moving image is reproduced, in operation S130.

As a result, if corresponding comments exists in the moving image, the control unit 140, for example, may extract a corresponding comment corresponding to the moving image, e.g., from the comment storage unit 130, in operation S150.

Whether modification of the extracted comment is needed may then be determined, in operation S160. For example, the control unit 140 may determine whether to modify the extracted comment in accordance with characteristics of the moving image and characteristics of the comment.

As a result, if modification of the extracted comment is needed, the extracted comment may be modified, e.g., by the control unit 140, in accordance with characteristics of the moving image and characteristics of the comment, in operation S170.

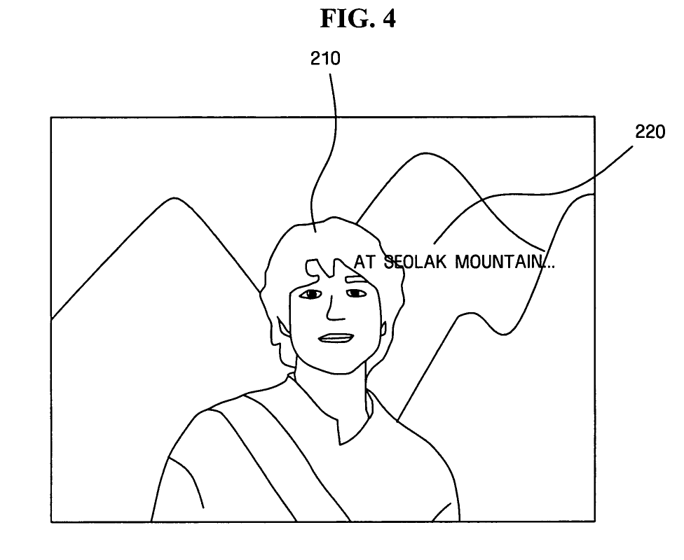

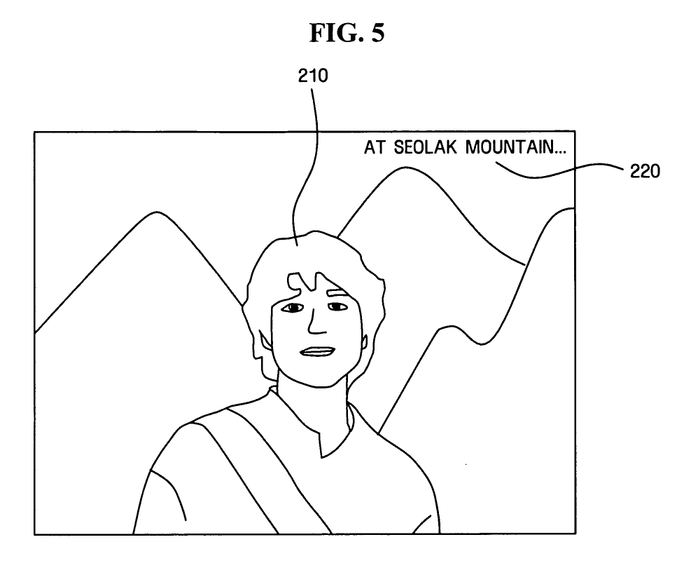

For example, the position of an extracted comment may be modified in accordance with a position of an object within the moving image among characteristics of the moving image. For example, the control unit 140 may modify the position 220 of the extracted comment, as shown in FIG. 5, so as not to overlap the position 210 of the object within the moving image if the position 210 of the object within the moving image overlaps the position 220 of the extracted comment, as shown in FIG. 4.

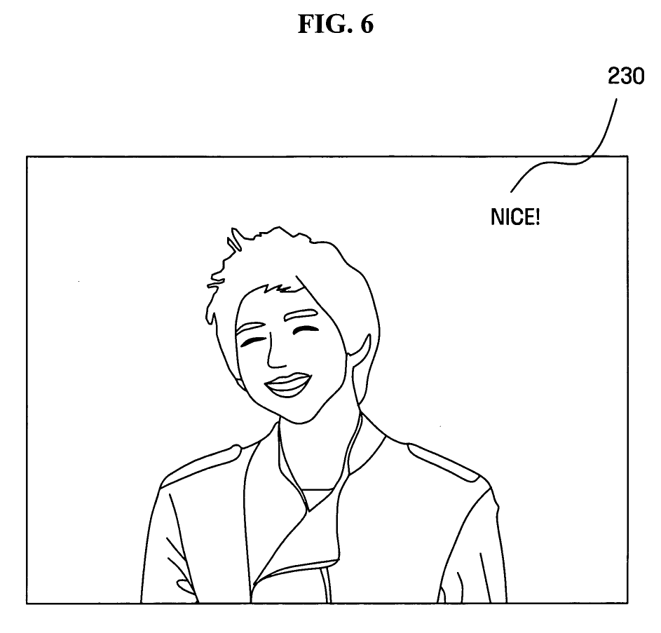

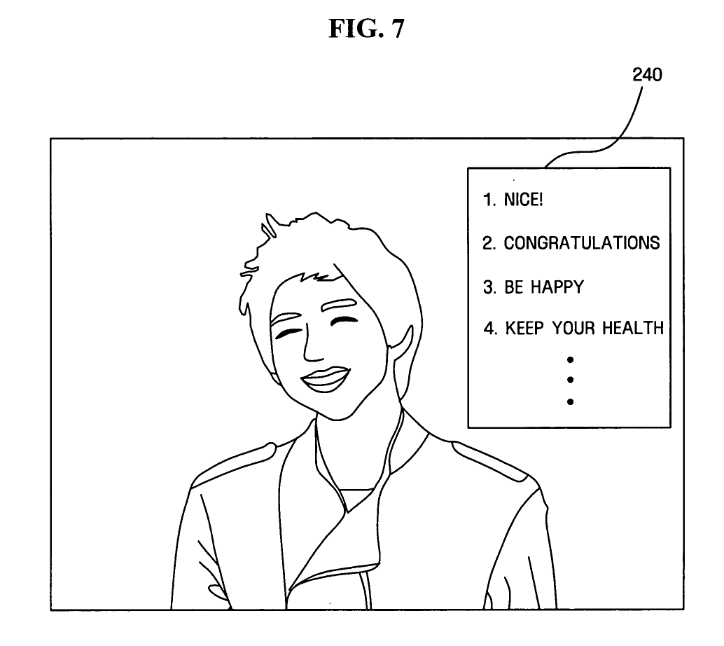

Furthermore, if too many comments already exist for the predetermined scene of the moving image, only a predetermined comment 230, as shown in FIG. 6, may be selected, e.g., by control unit 140. Here, in one embodiment, if a user desires to view all corresponding comments, the control unit 140 may output a comment listing 240 of comments existing in the predetermined scene, as shown in FIG. 7.

Then, the modified comment and the moving image may be reproduced together, e.g., by control unit 140, in operation S180.

If no comment corresponding to a moving image being reproduced exists, e.g., in the operation S140, only the moving image may be reproduced, e.g., by the control unit 140, in operation S1 90.

Here, if no modification of the extracted comment is needed, in operation S160, the extracted comment along with the moving image may be reproduced by skipping operation S170.

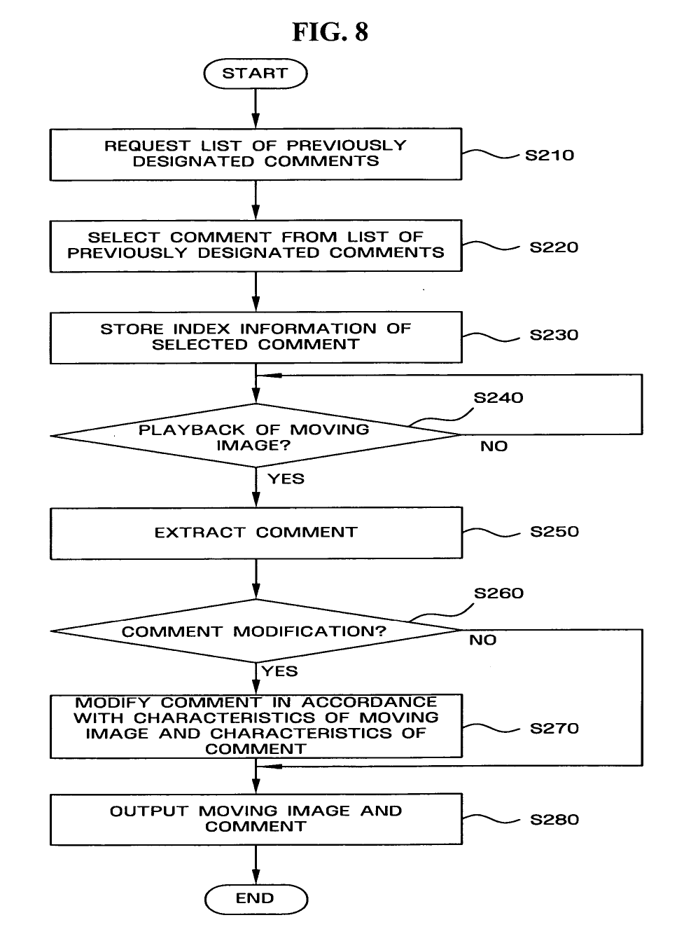

FIG. 8 illustrates a method of processing multimedia comments for moving images according to an embodiment of the present invention.

As shown in FIG. 8, a user may request a list of previously designated multimedia type comments for a moving image, e.g., as stored in the designated comment storage unit 150, in operation S210.

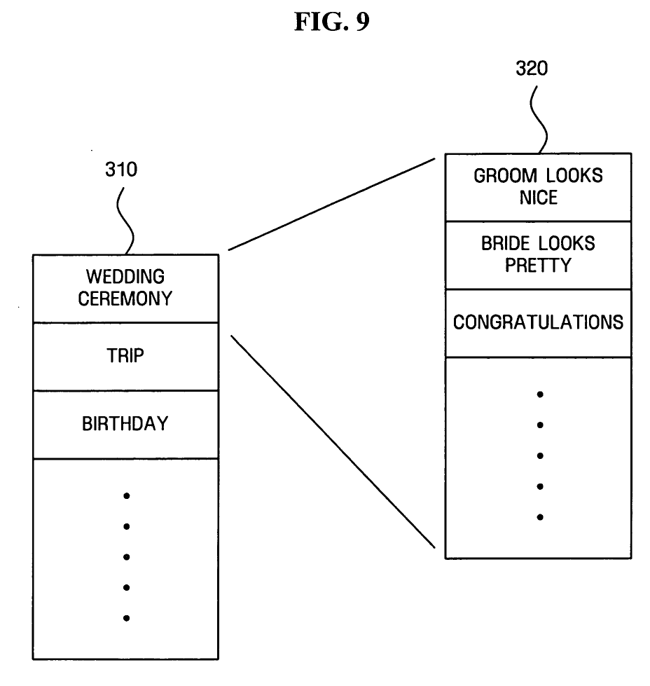

At this time, the listing of the previously designated multimedia type comments may be categorized in accordance with a theme of the moving image and a keyword. For example, the listing of the previously designated multimedia type comments, as shown in FIG. 9, may include a comment 320, such as “Groom looks nice,” “Bride looks pretty” and “Congratulations.” Of course, the list of FIG. 8 may alternatively, or in addition, include various multimedia type comments in addition to such text type comments.

The user may select a desired comment from the list of the previously designated multimedia type comments, in operation S220.

Index information corresponding to a comment selected by a user may further be stored, e.g., in the comment storage unit 130, in operation S230.

Then, the comment selected by the user may be extracted from a memory, e.g., extraction by control unit 140 of a designated comment storage unit 150 through the index information stored in the comment storage unit 130, in operation S250.

Whether modification of the extracted comment is needed may further be determined, e.g., by control unit 140, in operation S260. In one embodiment, the control unit 140 may determine whether to modify an extracted comment in accordance with characteristics of the moving image and characteristics of the comment.

As a result, if modification of the extracted comment is needed, the extracted comment may be modified, e.g., by control unit 140, in accordance with characteristics of the moving image and characteristics of the comment, in operation S270. Such a method of modifying the extracted comment may the same as that described above with regard to FIG. 3.

Further, the modified comment and the moving image may be reproduced together, e.g., by control unit 140, in operation S280.

If no modification of the extracted comment is needed, in operation S260, the extracted comment may be output/reproduced, e.g., by control unit 140, along with the moving image by skipping operation S270.

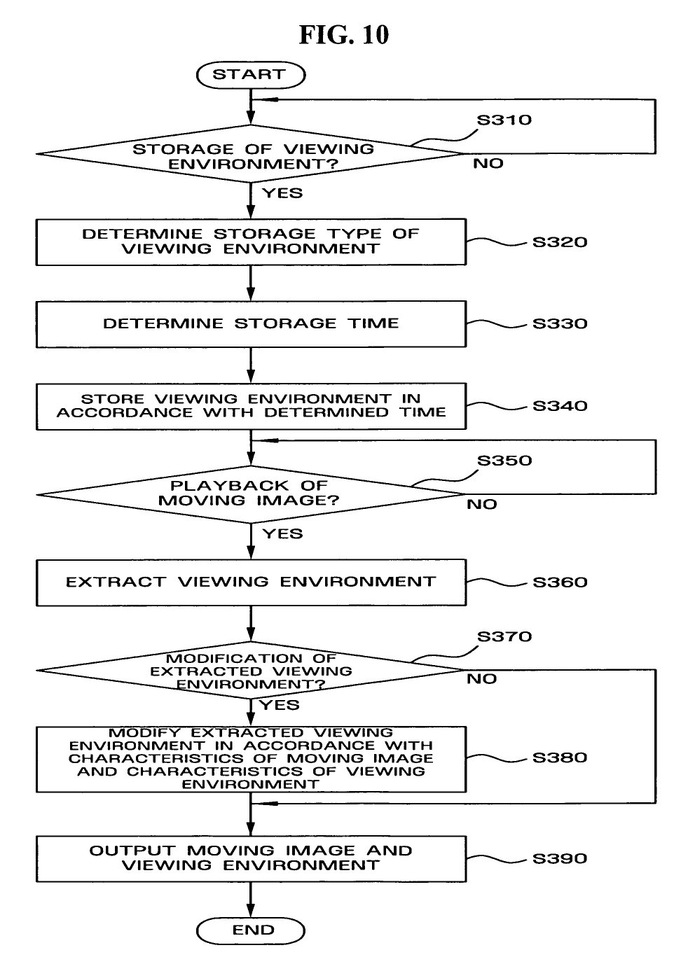

FIG. 10 illustrates a method of processing multimedia comments for moving images, according to an embodiment of the present invention.

As shown in FIG. 10, to store the viewing environment, a user may select whether to store the viewing environment while viewing the moving image, in operation S310.

If a user stores a viewing environment while viewing a moving image, the user may determine the storage type of the viewing environment, in operation S320. For example, if the user determines the storage type of the viewing environment as the moving image among image, moving image, voice and sound, the viewing environment may be stored as only the same type as that of the moving image.

Further, the user may determine when to store the viewing environment, in operation S330. In other words, a user may determine a storage time of the viewing environment when viewing the moving image. For example, the user may store the viewing environment at a predetermined time period or store the viewing environment only if a predetermined event is generated in the viewing environment. At this time, the event generated in the viewing environment corresponds to a case where sound at a predetermined level is generated from the surrounding of the user or the user takes a predetermined action. In one embodiment, the viewing environment storage unit 160 may store the viewing environment only if the event is generated.

In another embodiment, the viewing environment storage unit 160 may store the viewing environment in accordance with the determined storage time when the user views the moving image, in operation S340.

Further, the viewing environment, e.g., stored in the viewing environment storage unit 160, may be extracted, e.g., by the control unit 140, in operation S360, when the moving image stored in the moving image storage unit 120 is reproduced, in operation S350.

Whether modification of the extracted viewing environment is needed may be determined, e.g., by control unit 140, in operation S370. For example, the control unit 140 may determine whether to modify the extracted viewing environment in accordance with characteristics of the moving image and characteristics of the viewing environment. At this time, since the viewing environment may be of image, moving image, voice and sound in the same manner as the aforementioned comment, characteristics of the viewing environment may be understood as characteristics of the aforementioned comment.

If modification of the extracted viewing environment is needed, the extracted viewing environment may be modified, e.g., by the control unit 140, in accordance with characteristics of the moving image and characteristics of the viewing environment, in operation S380. Here, the method of modifying the extracted viewing environment may be similar to that of FIG. 3, for example.

Further, the modified viewing environment and the moving image may be reproduced/output, e.g., by control unit 140, together, in operation S390.

If no modification of the extracted viewing environment is needed in operation S370, the extracted viewing environment may be reproduced/output, e.g., by control unit 140, along with the moving image by skipping operation S380.

In addition to the above, methods for outputting comments directly input by a user, a comment selected from the previously designated comments and a viewing environment along with a moving image have been respectively shown in FIGS. 3, 8 and 10, only as examples. Here, these methods may also be selectively performed in differing combinations.

The present invention has been described herein with reference to the accompanying drawings illustrating block diagrams and flowcharts for explaining an apparatus, medium, and method for processing a multimedia comment for a moving image according to embodiments of the present invention. It will be understood that each block of the flowchart illustrations, and combinations of blocks in the flowchart illustrations, can be implemented by computer readable code

For example, such embodiments of the present invention may be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. Here, the medium may further be a signal, such as a resultant signal or bitstream, according to embodiments of the present invention. The media may also be a distributed network, so that the computer readable code is stored/transferred and executed in a distributed fashion. Still further, as only a example, the processing element could include a processor or a computer processor, and processing elements may be distributed and/or included in a single device.

Further, the term “unit”, as potentially used herein, in addition to any apparatus/device may mean, but is not limited to, a coding/software or hardware component, such as a Field Programmable Gate Array (FPGA) or Application Specific Integrated Circuit (ASIC), which performs certain tasks. A unit may advantageously be configured to reside on the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The described components and units may be combined into fewer components and units and/or further separated into additional components and units.

Also, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

Thus, as described above, an apparatus, medium, and method for processing a multimedia comment for a moving image, according to an embodiment of the present invention has at least the following advantages.

Since the user can input a comment for a predetermined scene in various multimedia types while viewing the moving image or selectively input the comment for the viewing moving image among the previously designated comments, it may be possible to allow the user to actively input the comment and to improve the user's convenience.

In addition, since the user may use a viewing environment as the comment, in addition to its desired comment input, it may be possible to allow the user to express its sensitiveness.

Although a few embodiments of the present invention have been shown and described, it would be appreciated by those skilled in the art that various modifications, additions and substitutions are possible without departing from the principles and spirit of the invention, the scope of which is defined in the claims and their equivalents.

What is claimed is:

1. An apparatus for processing multimedia comments for moving images, comprising:
a user input unit for a user to input a multimedia type comment for a particular moving image; and
a control unit to selectively modify the comment in accordance with characteristics of the moving image when the moving image is reproduced.

2. The apparatus of claim 1, wherein the multimedia type comment is of at least one type of a text, image, icon, moving image, voice, and sound type.

3. The apparatus of claim 1, wherein the input comment is stored together with synchronization information for a corresponding scene of the moving image.

4. The apparatus of claim 1, wherein the control unit modifies a multimedia type of the comment in accordance with characteristics of the moving image, which include a theme of the moving image, a keyword, a color distribution, and a position of an object within the moving image.

5. The apparatus of claim 1, wherein the control unit selectively outputs a select comment selected from a plurality of user input comments for a predetermined scene of the moving image in accordance with characteristics of the select comment.

6. The apparatus of claim 5, further comprising:
a designated comment storage to store previously designated user input comments in accordance with characteristics of the moving image; and
a viewing environment storage to store at least one viewing environment of the user in accordance with a user's indication for input of a comment when the moving image is reproduced.

7. The apparatus of claim 6, wherein the user selects at least one of the previously designated user input comments corresponding to the played moving image through the user input unit.

8. The apparatus of claim 7, wherein the control unit modifies the selected at least one of the previously designated user input comments in accordance with characteristics of the moving image when the moving image is reproduced.

9. The apparatus of claim 7, wherein the control unit modifies the selected at least one of the previously designated user input comments in accordance with characteristics of the selected at least one of the previously designated user comments when the moving image is reproduced.

10. The apparatus of claim 6, wherein the viewing environment storage stores at least one of a surrounding environment of the user and a viewing appearance of the user when the user views the reproduction of the moving image.

11. The apparatus of claim 10, wherein the at least one viewing environment is of at least one type of an image, moving image, voice, and sound type.

12. The apparatus of claim 10, wherein the viewing environment storage stores the at least one viewing environment at a predetermined time period or stores the at least one viewing environment according to a predetermined event being generated in the at least one viewing environment.

13. The apparatus of claim 10, wherein the control unit modifies the stored at least one viewing environment in accordance with characteristics of the moving image when the moving image is reproduced.

14. The apparatus of claim 10, wherein the control unit modifies the stored at least one viewing environment in accordance with characteristics of the at least one viewing environment when the moving image is reproduced.

15. The apparatus of claim 1, wherein the control unit controls a reproduction of the selectively modified comment together with the moving image.

16. A method of processing multimedia comments for moving images, comprising:
inputting a multimedia type comment by a user for a particular moving image; and
selectively modifying the comment in accordance with characteristics of the moving image when the moving image is reproduced.

17. The method of claim 16, wherein the multimedia type comment is of at least one type of a text, image, icon, moving image, voice, and sound type.

18. The method of claim 16, further comprising storing the comment together with synchronization information for a corresponding scene of the moving image corresponding to the comment.

19. The method of claim 16, further comprising outputting the comment through a selective modifying of a multimedia type of the comment in accordance with characteristics of the moving image, which include at least one of a theme of the moving image, a keyword, a color distribution, and a position of an object within the moving image.

20. The method of claim 16, wherein the inputting of the multimedia type comment further comprises selecting at least one of a plurality of previously designated user input comments for a predetermined scene of the moving image in accordance with characteristics of the selected comment.

21. The method of claim 16, further comprising:
storing previously designated user input comments in accordance with characteristics of the moving image; and
storing at least one viewing environment of the user in accordance with a user's indication for input of a comment when the moving image is reproduced.

22. The method of claim 21, wherein the inputting of the multimedia type comment further comprises selecting at least one of the previously designated user input comments corresponding to the reproduced moving image.

23. The method of claim 22, further comprising outputting the selected at least one of the previously designated user input comments through modifying of the selected at least one of the previously designated user input comments in accordance with characteristics of the moving image when the moving image is reproduced.

24. The method of claim 22, further comprising outputting the selected at least one of the previously designated user input comments through modifying the selected at least one of the previously designated user input comments in accordance with characteristics of the selected at least one of the previously designated user input comments when the moving image is reproduced.

25. The method of claim 21, further comprising viewing the at least one viewing environment through storing at least one of a surrounding environment of the user and a viewing appearance of the user when the user views the reproduction of the moving image.

26. The method of claim 21, wherein the at least one viewing environment is of at least one type of an image, moving image, voice, and sound type.

27. The method of claim 21, wherein the storing of the at least one viewing environment further comprises storing the at least one viewing environment at a predetermined time period or storing the at least one viewing environment if a predetermined event is generated in the at least one viewing environment.

28. The method of claim 21, further comprising outputting the comment through modifying the stored at least one viewing environment in accordance with characteristics of the moving image when the moving image is reproduced.

29. The method of claim 21, further comprising outputting the comment through modifying the stored at least one viewing environment in accordance with characteristics of the at least one viewing environment when the moving image is reproduced.

30. The method of claim 16, further comprising reproducing the selectively modified comment together with the moving image.

31. At least one medium comprising computer readable code to control at least one processing element to implement the method of claim 16.
